(19) United States
(12) Patent Application Publication
(10) Pub. No.: US 2014/0160006 A1
(43) Pub. Date: Jun. 12, 2014

(54) PROJECTION SYSTEM AND METHOD FOR CONTROLLING THE SAME

(71) Applicant: DELTA ELECTRONICS, INC., Taoyuan Hsien (TW)

(72) Inventor: Tung-Chin WU, Taoyuan Hsien (TW)

(73) Assignee: DELTA ELECTRONICS, INC., Taoyuan Hsien (TW)

(21) Appl. No.: 13/889,772

(22) Filed: May 8, 2013

(30) Foreign Application Priority Data
Dec. 11, 2012 (TW) 101146631

(51) Int. Cl. G06F 3/03

(52) U.S. Cl. CPC G06F 3/03
USPC 345/156

(57) ABSTRACT

A projection system includes an indicating device and a projection device, and the indicating device includes a button. When the button is pressed for the first time, the indicating device is configured to obtain a corresponding coordinate value and output a coordinate signal based on the coordinate value, and the projection device is configured to receive and process the coordinate signal to obtain and store the coordinate value. When the button is pressed for the second time in a first predetermined time, the projection device is configured to output a simulating double click signal to a computer. A method for controlling the projection system is also disclosed herein.

### RELATED APPLICATIONS

This application claims priority to Taiwan Application Serial Number 101146631, filed Dec. 11, 2012, which is herein incorporated by reference.

### BACKGROUND

1. Field of Invention

The embodiment of the present invention relates generally to a projection system and a method for controlling the same.

2. Description of Related Art

When teaching at school or giving a presentation during a meeting, an indicating device is often used. In operation, the indicating device can be used to simulate mouse functions such that users can use the indicating device to execute some simple operations.

However, when the indicating device is used to double click on an icon for an application, the double click operation often does not work due to the excessive displacement of the indicating device during the operation. That is, since there is no support for the indicating device unlike in the case of a mouse which is usually supported by, for example, a table surface, the indicating device undergoes excessive displacement during a double click operation so that the operation is not successfully performed.

There has been much effort in trying to find a solution to the aforementioned problems. Nonetheless, there is still a need to improve the existing apparatuses and techniques in the art.

### SUMMARY

One aspect of the embodiment of the present invention is to provide a projection system. The projection system comprises an indicating device and a projection device. The indicating device comprises a button. When the button is pressed, the indicating device obtains a corresponding coordinate value and outputs a coordinate signal based on the coordinate value. The projection device is configured to receive and process the coordinate signal to obtain the coordinate value. When the button is pressed for the first time, the projection device receives and stores a first coordinate value, and when the button is pressed for the second time in a first predetermined time, the projection device outputs a simulating double click signal corresponding to the first coordinate value to a computer.

In another aspect of the embodiment of the present invention, a method for controlling a projection system is provided. The method for controlling a projection system comprises the steps of:

detecting whether a button of an indicating device is pressed;

when the button being pressed for the first time, obtaining a corresponding first coordinate value and outputting a first coordinate signal based on the first coordinate value by the indicating device, and receiving and processing the first coordinate signal by the projection device to obtain and store the first coordinate value;

determining whether the button is pressed for the second time in a first predetermined time; and

when the button is pressed for the second time in the first predetermined time, outputting a simulating double click signal corresponding to the first coordinate value to a computer by the projection device.

As a result, the embodiments of the present invention provide the projection system and the method for controlling the projection system, which address the problem of a double click operation performed by an indicating device not working due to excessive displacement of the indicating device.

### BRIEF DESCRIPTION OF THE DRAWINGS

The invention can be more fully understood by reading the following detailed description of the embodiments, with reference made to the accompanying drawings as follows:

FIG. 1 is a perspective diagram of an indicating device according to embodiments of the present invention.

FIG. 2 is a schematic diagram showing displacement of the indicating device of FIG. 1 when a button of the indicating device is operated according to embodiments of the present invention.

FIG. 3 is a schematic diagram of a projection system according to embodiments of the present invention.

FIG. 4 is a timing diagram of a projection system according to embodiments of the present invention.

FIG. 5 is a circuit block diagram of a projection system according to embodiments of the present invention.

FIG. 6 is a flow diagram of a method for controlling a projection system according to embodiments of the present invention.

FIG. 7 is a flow diagram of a method for controlling a projection system according to embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, the terms “comprising,” “including,” “having,” “containing,” “involving,” and the like are to be understood to be open-ended, i.e., to mean including but not limited to.

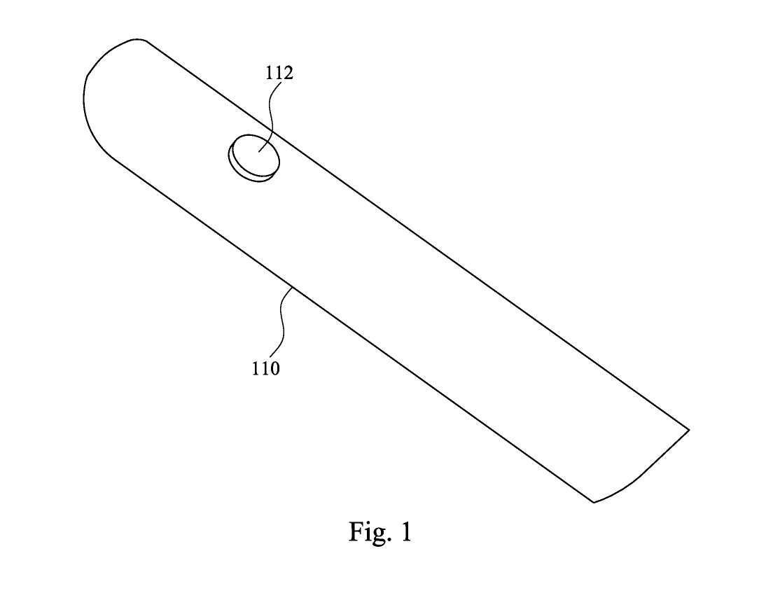

FIG. 1 is a perspective diagram of an indicating device according to embodiments of the present invention. As shown in the figure, an indicating device 110 comprises a button 112. When implementing the present invention, the indicating device 110 can be a pen-type device. This pen-type device can be used to simulate a computer mouse. For example, the button 112 can be used to simulate the left button of the computer mouse. In one embodiment, the pen-type device can further comprise a pen nib (not shown) which can be used to write. As a result, the pen-type device of the embodiment of the present invention not only can simulate a computer mouse to execute some simple operations, but its pen nib can be used to write such that users can operate the pen-type device with more convenience when teaching or giving a presentation.

However, the above mentioned implementation of the indicating device 110 is not intended to limit the present invention, and this configuration is merely used to describe one implementation of the present invention. It should be understood by those skilled in the art that any implementation of the indicating device 110 can remain within the scope of the present invention without departing from the spirit and scope of the invention as defined by the appended claim.

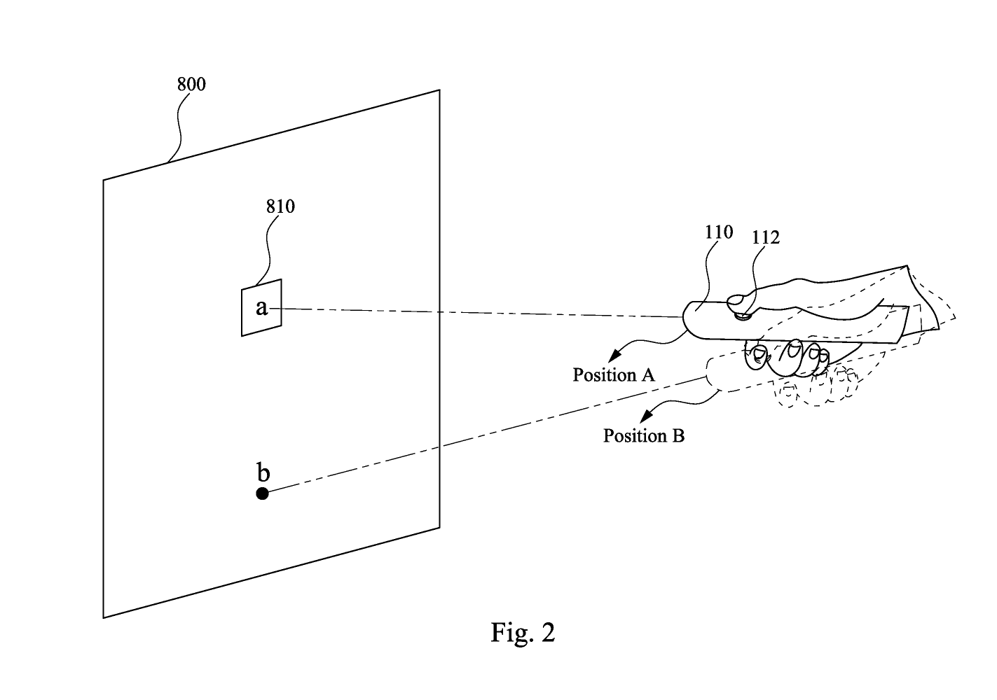

When employing the indicating device 110 to simulate a computer mouse for executing some simple operations, a problem may be encountered, as shown in FIG. 2. FIG. 2 is a schematic diagram showing displacement of the indicating device 110 of FIG. 1 when the button 112 of the indicating device 110 is operated according to embodiments of the present invention. When users need to select an icon 810 on a screen 800 that corresponds to a particular application, first of all, users aim the indicating device 110 at the icon 810, and then press the button 112 for the first time. During this operation, the location of the indicating device 110 is at position A, and the indicating device 110 is aimed at point “a” of the screen 800.

An operating system (OS) may be configured corresponding to the indicating device 110 to receive a double click signal to subsequently execute the corresponding application. However, when users press the button 112 of the indicating device 110 for the second time, execution of the application is not often successful because the indicating device 110 is not supported by, for example, a table surface, and the hand of the user will shake, such that the position of the indicating device 110 changes to position B. Consequently, the indicating device 110 is aimed at point “b” of the screen 800, which is different from point “a” of the screen 800 corresponding to the icon 810. Thus, execution of the application will not occur.

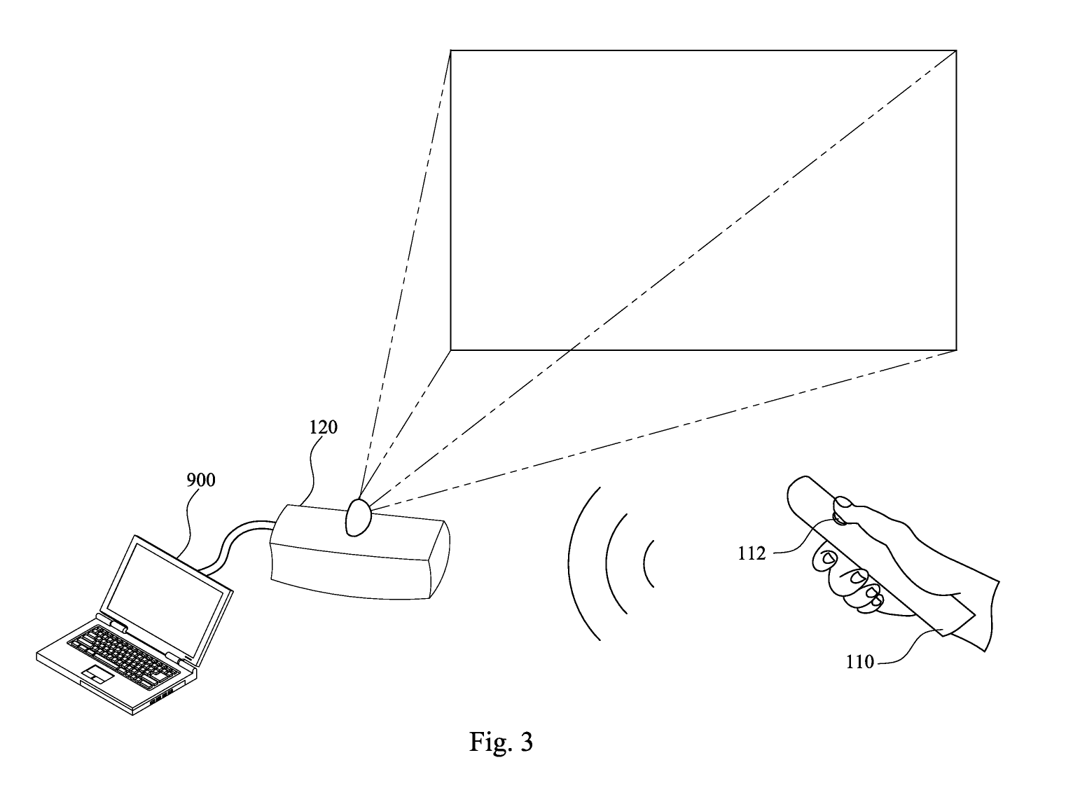

For solving the above-mentioned problem, the embodiment of the present invention provides a projection system as shown in FIG. 3. FIG. 3 is a schematic diagram of a projection system according to embodiments of the present invention. As shown in the figure, the projection system comprises the indicating device 110 as shown in FIG. 1 and a projection device 120.

When the button 112 is pressed, the indicating device 110 obtains a corresponding coordinate value and outputs a coordinate signal based on the coordinate value. The projection device 120 is configured to receive and process the coordinate signal to obtain the coordinate value. Hence, the indicating device 110 and the projection device 120 can cooperate with each other. In a word, the projection device 120 can receive the corresponding coordinate value generated by the indicating device 110 when the button 112 is pressed.

When the button 112 is pressed for the first time, the projection device 120 receives and stores a first coordinate value. After the button 112 is pressed for the second time during a first predetermined time, the projection device 120 outputs a simulating double click signal corresponding to the first coordinate value to a computer 900. In greater detail, the projection device 120 can store the first coordinate value generated by the button 112 being pressed for the first time. If the operation of pressing the button 112 twice is regarded as a double click operation (for example, the time duration between the button 112 being pressed for the first time and pressed for the second time is not longer than the first predetermined time), the projection device 120 outputs the simulating double click signal corresponding to the first coordinate value to the computer 900. Since the first coordinate value is the coordinate value of the indicating device 110 for the button 112 being pressed for the first time, the computer 900 will execute the application with the icon 810 on the screen 800 (see FIG. 2) corresponding to the coordinate value.

In one embodiment, for further ensuring that the operation of the button 112 being pressed twice is corresponding to a double click operation, the embodiment of the present invention further introduces a space limitation in addition to the time limitation discussed above (i.e., the time duration between two presses is not longer than the first predetermined time). Specifically, referring to FIG. 2, such a space limitation is that the distance between the position of the indicating device 110 for the first time button 112 press and that for the second time button 112 press does not exceed a predetermined range. For example, the points “a” and “b” do not exceed the predetermined range. If this condition is satisfied, the operation of the button 112 when it is pressed twice is deemed to correspond to a double click operation.

For example, when the button 112 is pressed for the second time within the first predetermined time, the projection device 120 is further used to receive and store a corresponding second coordinate value. The projection device 120 is configured to then determine whether the first coordinate value and second coordinate value are within the predetermined range. When the first coordinate value and second coordinate value are within the predetermined range, the projection device 120 outputs the simulating double click signal corresponding to the first coordinate value to the computer 900.

It is noted that the predetermined range can be position-based or distance-based. If the predetermined range is position-based, before the projection device 120 makes a determination, a plurality of permitted coordinate values are calculated based on the first coordinate value. Subsequently, the projection device 120 can determine whether the second coordinate value corresponds to one of the permitted coordinate values. On the other hand, if the predetermined range is distance-based, the projection device 120 merely needs to define a permitted distance, and then the projection device 120 calculates the distance between the first and the second coordinate values and determines whether this distance is less than (or possibly also equal to) the permitted distance. When it is desired to optimize accuracy, the embodiment of the present invention can adopt a configuration in which the predetermined range is position-based. However, when it is desired to optimize speed, the embodiment of the present invention can adopt a configuration in which the predetermined range is distance-based. However, the above mentioned implementation of the embodiment is not intended to limit the present invention, and this configuration is merely used to describe one implementation of the present invention. Those skilled in the art can selectively adopt an appropriate configuration to implement the present invention.

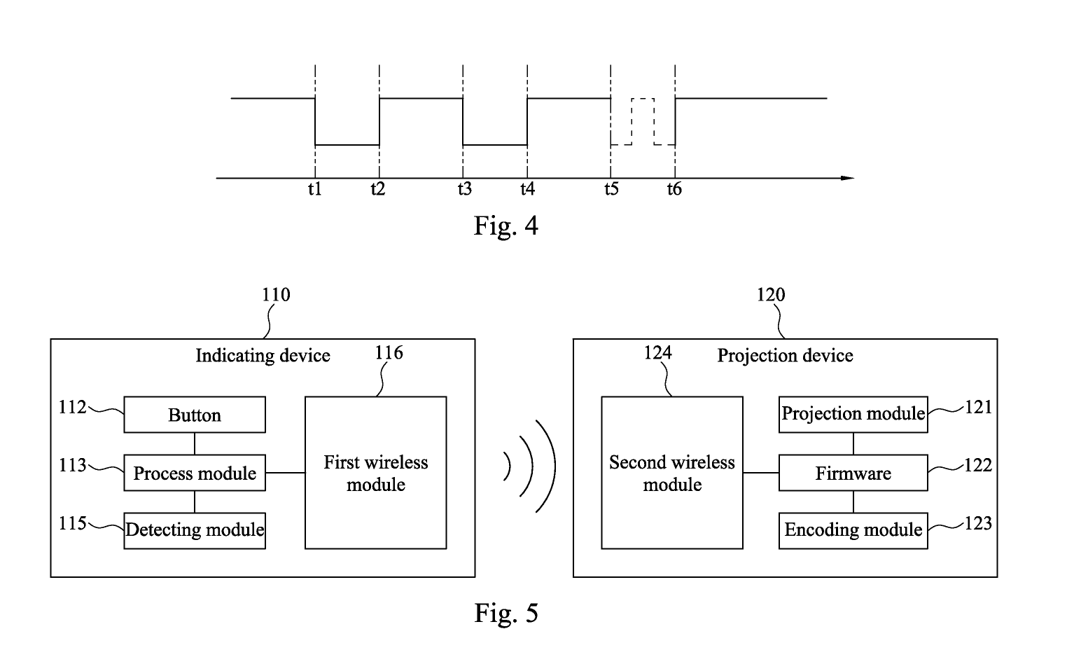

To easily understand the operation of the present invention, reference is made to FIG. 4 which is a timing diagram of a projection system according to embodiments of the present invention. In FIG. 4, t1 represents the time point at which the button 112 is pressed for the first time, t3 represents the time point at which the button 112 is pressed for the second time, and t2 and t4 represent the time points at which the button 112 is released. Furthermore, the interval from t1 to t3 represents the time duration between two presses of the button 112.

To make the two presses of the button 112 recognized as a double click operation by the operating system, the time duration between two presses of the button 112 needs to be shorter than the first predetermined time. In some embodiments, the first predetermined time is between about 200 ms and about 500 ms. In some other embodiments, the first predetermined time is between about 250 ms and about 450 ms. In still some other embodiments, the first predetermined time is between about 300 ms and about 400 ms. However, the duration of the first predetermined time is not intended to limit the present invention, and those skilled in the art can selectively adopt an appropriate time duration for the first predetermined time.

In one embodiment of the present invention, as described above, the indicating device 110 can be a pen-type device, and the pen-type device comprises a pen nib such that the pen-type device can be used to write. In such an embodiment, the pen nib and the button 112 are connected such that both the pen nib and the button 112 can be used to simulate a left button of a mouse. For example, if the pen nib is used to write two strokes on the screen 800 within the first predetermined time, such an operation may be regarded as a double click operation. In one embodiment of the present invention, for preventing an erroneous determination of a double click operation, a prevention mechanism is further designed into the embodiment of the present invention. The prevention mechanism functions such that the projection device 120 outputs the simulating double click signal to the computer 900 based on the first coordinate value after the elapse of a second predetermined time which is calculated starting from when the button 112 is released for the second time. If the pen nib is used to write a third stroke on the screen 800 within the second predetermined time starting from the second release, which is equivalent to the button 112 being pressed for a third time, the double click operation will not be considered to be an actual or intended double click operation, and as a result, the projection device 120 will not output the simulating double click signal to the computer 900. Hence, erroneous determination of a double click operation is prevented.

Referring again to FIG. 4, the interval from t4 to t5 as shown in the figure represents the second predetermined time. To enable the prevention mechanism to operate correctly, in some embodiments, the second predetermined time is between about 100 ms and about 200 ms. In some other embodiments, the second predetermined time is between about 120 ms and about 180 ms. In still some other embodiments, the second predetermined time is between about 140 ms and about 160 ms. However, the duration of the second predetermined time is not intended to limit the present invention, and those skilled in the art can selectively adopt an appropriate time duration for the second predetermined time. In addition, the transmitted signal during the time interval from t5 to t6 in the figure represents the simulating double click signal outputted by the projection device 120.

FIG. 5 is a circuit block diagram of a projection system according to embodiments of the present invention. As shown in the figure, the indicating device 110 further comprises a process module 113, a detecting module 115, and a first wireless module 116, and the projection device 120 further comprises a projection module 121, a firmware 122, an encoding module 123, and a second wireless module 124. With respect to the indicating device 110, the process module 113 is electrically coupled between the button 112 and the detecting module 115 and electrically coupled to the first wireless module 116. With respect to the projection device 120, the firmware 122 is electrically coupled between the projection module 121 and the encoding module 123 and electrically coupled to the second wireless module 124. However, the connection of the inner elements of the projection system of the embodiment of the present invention is not intended to be limited to the connection shown in FIG. 5, and this configuration is merely used to describe one implementation of the present invention.

In one embodiment of the present invention, referring to FIG. 5, the first wireless module 116 of the indicating device 110 is configured to transmit the coordinate signal to the projection device 120 wirelessly. The second wireless module 124 of the projection device 120 is configured to receive the coordinate signal wirelessly. As a result, communication between the indicating device 110 and the projection device 120 can be wirelessly performed. However, the above-mentioned implementation is not intended to limit the present invention, and those skilled in the art can selectively utilize a wired or wireless connection based on actual requirements.

In another embodiment of the present invention, the encoding module 123 of the projection device 120 is configured to encode a pattern into image data for forming a coordinate image. The coordinate image can be processed by the firmware 122 and projected by the projection module 121. When the coordinate image is projected on a screen, the detecting module 115 of the indicating device 110 is configured to detect the projected image to receive the coordinate image, and the coordinate image is processed by the process module 113 for obtaining the corresponding first coordinate value when the button 112 is pressed.

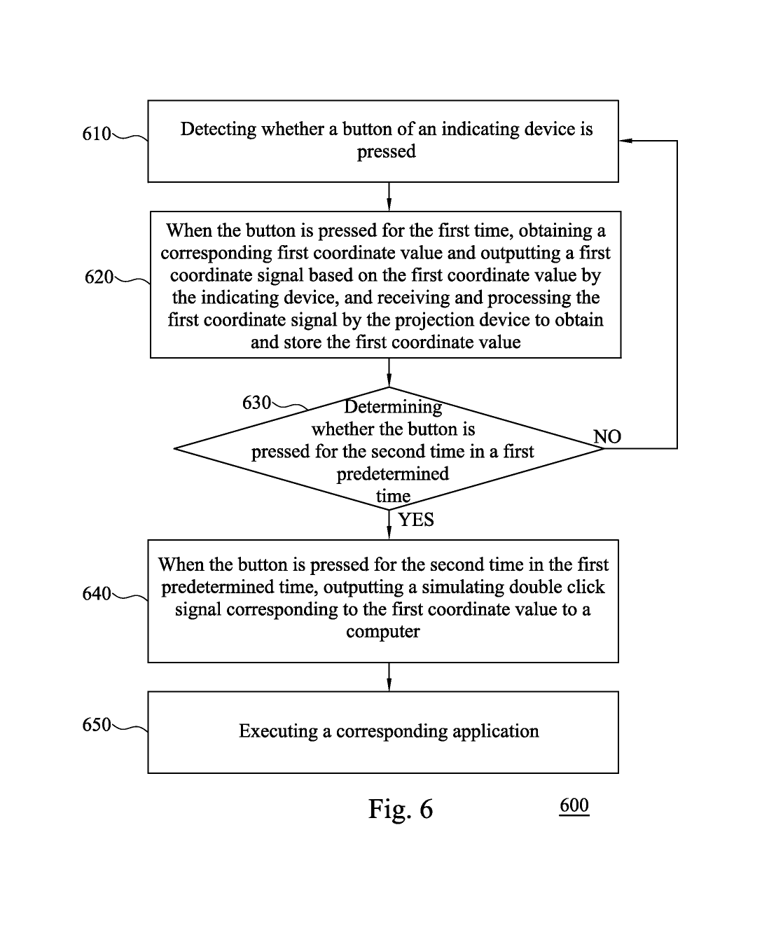

To easily understand the operation of the present invention, reference is made to both FIGS. 5 and 6 to describe the steps of the operation. FIG. 6 is a flow diagram of a method for controlling a projection system according to embodiments of the present invention. As shown in the figure, the method 600 for controlling the projection system comprises the following steps:

detecting whether a button of an indicating device is pressed (step 610);

when the button is pressed for the first time, obtaining a corresponding first coordinate value and outputting a first coordinate signal based on the first coordinate value by the indicating device, and receiving and processing the first coordinate signal by the projection device to obtain and store the first coordinate value (step 620);

determining whether the button is pressed for the second time in a first predetermined time (step 630);

when the button is pressed for the second time in the first predetermined time, outputting a simulating double click signal corresponding to the first coordinate value to a computer (step 640); and

executing a corresponding application (step 650).

In step 610, the detecting module 115 as shown in FIG. 5 can be used to detect whether the button 112 of the indicating device 110 is pressed. In step 620, when the process module 113 determines that the button 112 is pressed for the first time, the indicating device 110 is used to obtain the corresponding first coordinate value and output the first coordinate signal based on the first coordinate value, and the projection device 120 is used to receive and process the first coordinate signal to obtain and store the first coordinate value.

Subsequently, step 630 of determining whether the button 112 is pressed for the second time in the first predetermined time can be performed by the process module 113. In step 640, after the process module 113 determines that the button 112 is pressed for the second time within the first predetermined time, the projection device 120 is used to output the simulating double click signal corresponding to the first coordinate value to the computer 900 based on the first coordinate value. Step 650 can then be performed by the computer 900 based on the simulating double click signal.

In one embodiment, for further ensuring that the operation of the button 112 being pressed twice is corresponding to a double click operation, the embodiment of the present invention further introduces a space limitation in addition to the time limitation associated with step 640 discussed above (i.e., the time duration between two presses is not longer than the first predetermined time). Specifically, referring to FIG. 2, such a space limitation is that the distance between the position of the indicating device 110 for the first time button press and that for the second time button press does not exceed a predetermined range, for example, the points “a” and “b” do not exceed the predetermined range.

For example, when the button 112 is pressed for the second time within the first predetermined time, the projection device 120 is further used to receive and store a corresponding second coordinate value. The projection device 120 is configured to then determine whether the first coordinate value and second coordinate value are within the predetermined range. When first coordinate value and second coordinate value are within the predetermined range, the projection device 120 outputs the simulating double click signal corresponding to the first coordinate value to the computer 900 based on the first coordinate value. Details with respect to the manner in which the projection device 120 determines the predetermined range have been explained above, and accordingly, a detailed description in this regard is omitted herein for the sake of brevity.

In one embodiment of the present invention, the method 600 for controlling the projection system further comprises the steps of determining whether the button 112 is pressed for the third time in a second predetermined time subsequent to the second time button press, and outputting the simulating double click signal to the computer 900 if the button is not pressed for the third time in the second predetermined time. Details with respect to the first predetermined time and second predetermined time are described with reference to FIG. 4, and accordingly, will be omitted herein for the sake of brevity.

In another embodiment of the present invention, the step of outputting the coordinate signal based on the coordinate value by the indicating device 110 involves transmitting the coordinate signal wirelessly by the first wireless module 116 of the indicating device 110. In addition, the step of receiving the coordinate signal by the projection device involves receiving the coordinate signal wirelessly by the second wireless module 124 of the projection device 120. As a result, communication between the indicating device 110 and the projection device 120 can be realized wirelessly. However, the above-mentioned implementation is not intended to limit the present invention, and those skilled in the art can selectively utilize a wired or wireless connection based on actual requirements.

In still another embodiment of the present invention, the method 600 for controlling the projection system further comprises the steps of encoding a pattern into image data for forming a coordinate image, and projecting the coordinate image. Specifically, in the above-mentioned steps, the encoding module 123 as shown in FIG. 5 can be used to encode the pattern into image data for forming the coordinate image. In addition, the projection module 121 can be used to project the coordinate image. The indicating device 110 is then used to receive the corresponding first coordinate value. Specifically, the indicating device 110 is used to detect and process the coordinate image for obtaining the corresponding first coordinate value.

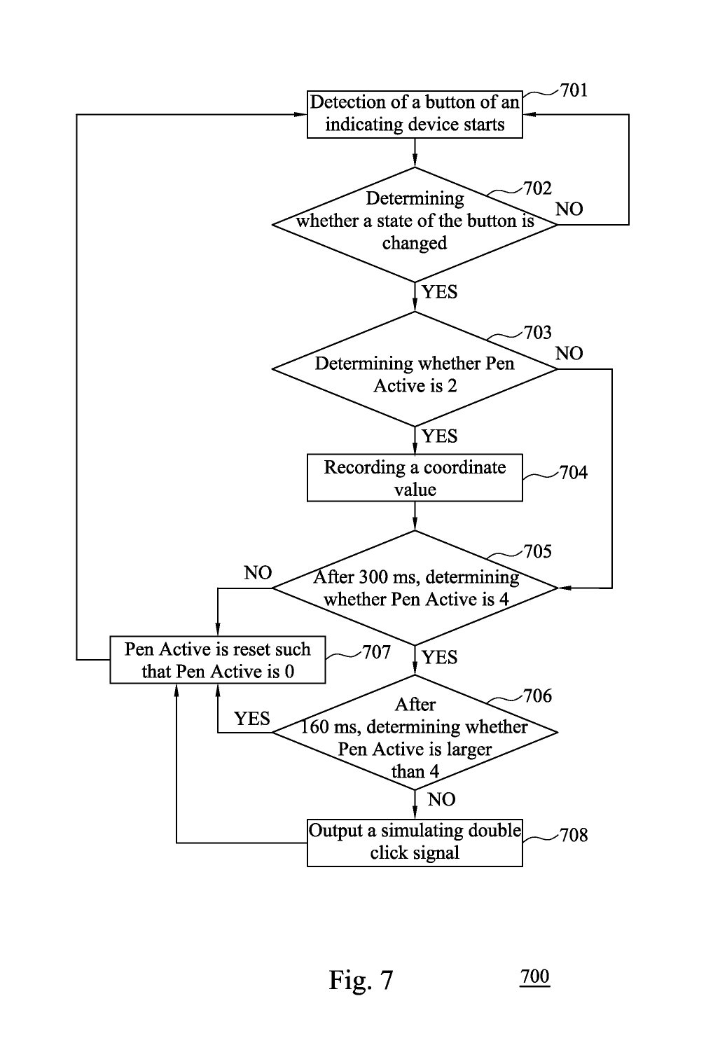

FIG. 7 is a flow diagram of a method for controlling a projection system according to embodiments of the present invention. First, a detection of a button of an indicating device starts (step 701). Next, a determination is made as to whether a state of the button is changed (step 702). When the state of the button has changed, a determination is made as to whether a button command (Pen Active) is 2 (step 703). On the other hand, when the state of the button is not changed, step 701 is executed again to determine whether the state of the button has changed. The button command (Pen Active) can be used to represent the state of the button. When the button is pressed, the button command (Pen Active) is incremented by 1. Subsequently, when the button is released, the button command (Pen Active) is again incremented by 1.

Subsequently, when the button command (Pen Active) is determined to be 2, the projection device is used to record a coordinate value (step 704), after which step 705 is then executed. On the other hand, when the button command (Pen Active) is not determined to be 2, step 705 is executed immediately.

In step 705, after 300 ms, a determination is made as to whether the button command (Pen Active) is 4. When the button command (Pen Active) is determined to be 4, step 706 is executed. On the other hand, when the button command (Pen Active) is not determined to be 4, step 707 is executed to reset the button command (Pen Active) such that the button command is 0, after which step 701 is executed again.

In step 705, when the button command (Pen Active) is determined to be 4, the button is deemed to have been pressed twice. After 160 ms, a step of determining whether the button command (Pen Active) is larger than 4 is executed. When the button command (Pen Active) is not larger than 4, this indicates that the button has not been pressed again in said 160 ms, thus ensuring that the button has been double clicked. Simultaneously, the projection module 120 is used to output a simulating double click signal (step 708). The Pen Active is then reset to 0, and step 701 is executed again. On the other hand, when the button command (Pen Active) is larger than 4, this indicates that the button has been pressed again in said 160 ms. In such a situation, a user may be using the indicating device to write but not for a double click operation. At this time, the button command (Pen Active) is reset to 0, after which step 701 is executed again.

Those having skill in the art will appreciate that the method 600 for controlling the projection system can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the method 600 for controlling the projection system named after the function thereof is merely used to describe the technology in the embodiment of the present invention in detail, but the present invention is not limited in this respect. Therefore, combining the steps of said method into one step, dividing the steps into several steps, or rearranging the order of the steps all fall within the scope of the embodiments in the present invention.

In view of the foregoing embodiments of the present invention, many advantages of the present invention are now apparent. The embodiments of the present invention provide the projection system and the method for controlling the projection system, which address the problem of a double click operation performed by the indicating device not working due to excessive displacement of the indicating device.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A projection system, comprising:
an indicating device comprising a button, wherein when the button is pressed, the indicating device obtains a corresponding coordinate value and outputs a coordinate signal based on the coordinate value; and
a projection device configured to receive and process the coordinate signal to obtain the coordinate value;
wherein when the button is pressed for the first time, the projection device receives and stores a first coordinate value, and when the button is pressed for the second time in a first predetermined time, the projection device outputs a simulating double click signal corresponding to the first coordinate value to a computer.

2. The projection system according to claim 1, wherein when the button is pressed for the second time in the first predetermined time, the projection device receives and stores a corresponding second coordinate value, wherein the projection device is configured to determine whether the first coordinate value and the second coordinate value are in a predetermined range, and when the first coordinate value and the second coordinate value are in the predetermined range, the projection device outputs the simulating double click signal corresponding to the first coordinate value to the computer.

3. The projection system according to claim 1, wherein the first predetermined time is between about 200 ms and about 500 ms.

4. The projection system according to claim 1, wherein after a second predetermined time subsequent to the button being pressed for the second time, the projection device outputs the simulating double click signal to the computer.

5. The projection system according to claim 4, wherein the second predetermined time is between about 100 ms and about 200 ms.

6. The projection system according to claim 1, wherein the indicating device further comprises a first wireless module, and the first wireless module is configured to transmit the coordinate signal to the projection device wirelessly.

7. The projection system according to claim 6, wherein the projection device further comprises a second wireless module, and the second wireless module is configured to receive the coordinate signal wirelessly.

8. The projection system according to claim 1, wherein the projection device further comprises:
a projection module; and
an encoding module electrically coupled to the projection module and configured to encode a pattern into image data for forming a coordinate image, wherein the coordinate image is projected by the projection module.

9. The projection system according to claim 8, wherein the indicating device further comprises:
a detecting module configured to detect and process the coordinate image for obtaining the corresponding first coordinate value when the button is pressed.

10. A method for controlling a projection system comprising:
detecting whether a button of an indicating device is pressed;
when the button is pressed for the first time, obtaining a corresponding first coordinate value and outputting a first coordinate signal based on the first coordinate value by the indicating device, and receiving and processing the first coordinate signal by the projection device to obtain and store the first coordinate value;
determining whether the button is pressed for the second time in a first predetermined time; and
when the button is pressed for the second time in the first predetermined time, outputting a simulating double click signal corresponding to the first coordinate value to a computer by the projection device.

11. The method for controlling the projection system according to claim 10, wherein the step of when the button is pressed for the second time in the first predetermined time, outputting the simulating double click signal corresponding to the first coordinate value to the computer by the projection device comprises:
when the button is pressed for the second time in the first predetermined time, receiving and storing a corresponding second coordinate value by the projection device;
determining whether the first coordinate value and the second coordinate value are in a predetermined range by the projection device; and
when the first coordinate value and the second coordinate value are in the predetermined range, outputting the simulating double click signal corresponding to the first coordinate value to the computer by the projection device.

12. The method for controlling the projection system according to claim 10, wherein the first predetermined time is between about 200 ms and about 500 ms.

13. The method for controlling the projection system according to claim 10, further comprising:
determining whether the button is pressed for the third time in a second predetermined time subsequent to the button being pressed for the second time;
when the button is not pressed for the third time in the second predetermined time, outputting the simulating double click signal to the computer by the projection device.

14. The method for controlling the projection system according to claim 13, wherein the second predetermined time is between about 100 ms and about 200 ms.

15. The method for controlling the projection system according to claim 10, wherein the step of outputting the coordinate signal based on the coordinate value by the indicating device comprises:
transmitting the coordinate signal wirelessly by a wireless module of the indicating device.

16. The method for controlling the projection system according to claim 10, wherein the step of receiving the coordinate signal by the projection device comprises:
receiving the coordinate signal wirelessly by a wireless module of the projection device.

17. The method for controlling the projection system according to claim 10, further comprising:
encoding a pattern into image data for forming a coordinate image; and
projecting the coordinate image;
wherein the step of obtaining the corresponding first coordinate value by the indicating device comprises:
detecting and processing the coordinate image for obtaining the corresponding first coordinate value by the indicating device.
